(19) United States
(12) Patent Application Publication
(10) Pub. No.: US 2010/0270269 A1
(43) Pub. Date: Oct. 28, 2010

(54) WELDING APPARATUS AND METHOD OF WELDING

(75) Inventors: Alexander D. Khakhalev, Troy, MI (US); Jay Hampton, Lenox, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/427,921

(22) Filed: Apr. 22, 2009

(51) Int. Cl. B23K 28/00

(52) U.S. Cl. 219/74

(57) ABSTRACT

A welding apparatus for welding a work piece is provided that has a weld gun with a nozzle body having an inner surface defining a cavity, and a distal opening forming a nozzle orifice. An electrode extends in the cavity and is configured to be positionable proximate the work piece. The weld gun is configured to provide a flow of shielding gas through the nozzle orifice. The welding apparatus is configured to position the nozzle orifice at a distance from the work piece sufficient to cause the inner surface to direct weld spatter to a weld pool on the work piece adjacent the nozzle. Additionally, the distance is such that laminar flow of the shielding gas is maintained under the predetermined gas flow rate.

### TECHNICAL FIELD

The invention relates to a welding apparatus.

### BACKGROUND OF THE INVENTION

Robotic welding assemblies are commonly used to weld manufactured components, such as vehicle components. Gas metal arc welding, including metal inert gas (“MIG”) welding, is a high deposition rate process suitable for high production welding applications, such as assembly line processes. Wire is continuously fed from a spool, and a shielding gas is emitted around the area to be welded in order to keep ambient air away from the weld surface, as air tends to oxidize the weld, making the weld porous. A common problem with MIG welding is weld spatter, i.e., pieces of weld or weld material that break free from the wire or from the weld pool, wasting material and creating cleanup issues.

### SUMMARY OF THE INVENTION

A welding apparatus for welding a work piece is provided that has a welding gun with a nozzle body having an inner surface defining a cavity, and a distal opening forming a nozzle orifice. An electrode extends in the cavity and is configured to be positionable proximate the work piece. The weld gun is configured to provide a flow of shielding gas through the nozzle. The welding apparatus is configured to position the nozzle orifice at a distance from the work piece sufficient to cause the inner surface to direct weld spatter to a weld pool on the work piece adjacent the nozzle. Additionally, the distance is selected such that laminar flow of the shielding gas is maintained under the predetermined gas flow rate. A controller may be used to establish the position and maintain the laminar flow. The laminar flow helps reduce turbulence in the area of the weld pool, provide adequate protection of the weld pool from ambient air and reduces the tendency to blow the weld spatter away from the weld pool, and instead promotes the ability of the weld gun nozzle to direct the spatter into the weld pool, or toward the weld pool to be pulled therein via surface tension. This reduces waste of the weld material, e.g., reduces stray spatter, and promotes the ability of the shielding gas to minimize oxidation of the weld, to prevent poor porosity. Additionally, the relatively small distance reduces required flow rate of the shielding gas, minimizing energy costs.

Various embodiments of the welding gun are provided, including, without limitation, an embodiment with a nozzle body having a concave inner surface to direct weld spatter, an embodiment with a threaded, removable extended nozzle portion, and various spring-loaded nozzle embodiments that allow the nozzle body to spring back to a position in which the nozzle orifice is at a desired distance from the work piece if temporarily displaced, such as when bumped by a work piece.

The predetermined position may be electronically controlled, such as by a robotic welding apparatus that includes a base configured to support the work piece during welding, a welding gun defining a cavity surrounding an electrode and having a distal opening forming a nozzle orifice configured to be positionable proximate the work piece, with the weld gun being configured to provide a flow of shielding gas through the cavity and nozzle orifice. A controller is operatively connected to the welding gun and is operable to position the nozzle orifice, preferably not more than 3 millimeters from the work piece during the welding.

A method of welding a work piece thus includes controlling a distance between the welding gun and the work piece when welding the work piece to permit weld spatter to deflect off of the welding gun nozzle into or toward a weld pool on the work piece, while also controlling a rate of shielding gas flow through the weld gun so that laminar flow of shielding gas from the weld gun is maintained.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in partial cross-sectional side view of a first embodiment of a welding apparatus;

FIG. 2 is a schematic illustration in partial cross-sectional side view of a second embodiment of a welding apparatus;

FIG. 3 is a schematic illustration in partial cross-sectional side view of a third embodiment of a welding apparatus; and

FIG. 4 is a schematic illustration in partial cross-sectional side view of a fourth embodiment of a welding apparatus.

### DESCRIPTION OF THE PREFERRED EMBODIMENTS

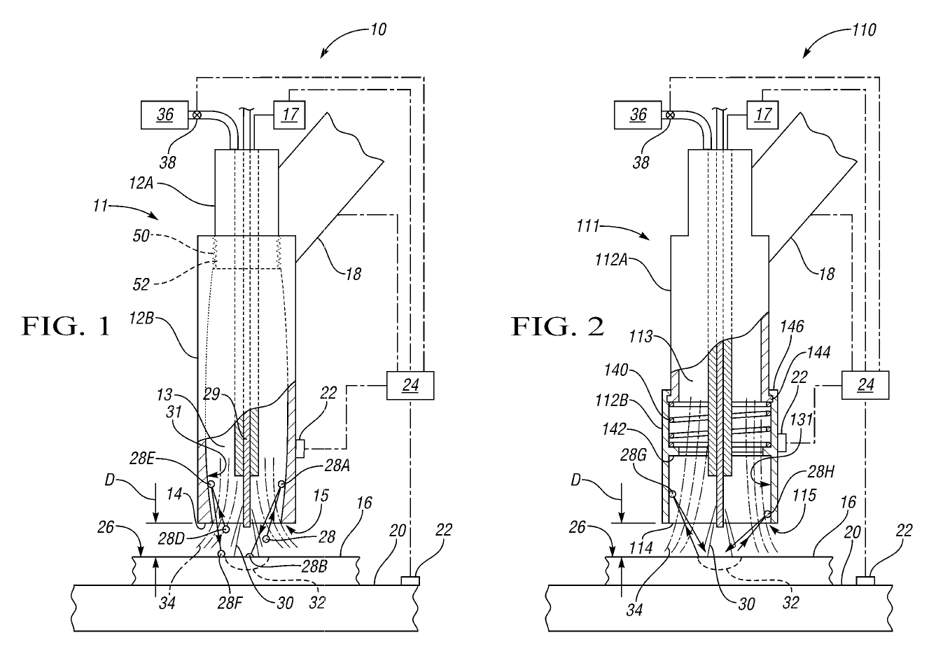

Referring to the drawings, wherein like reference numbers refer to like components throughout the several views, FIG. 1 shows a robotic welding apparatus 10 that includes a welding gun 11 with a nozzle body 12A, 12B having a first nozzle body portion 12A and a second nozzle body portion 12B, each having threads, outer threads 50 and inner threads 52, respectively, matable with one another. Nozzle body portion 12B has a cavity 13 and a distal opening 14 forming a gas nozzle orifice 15. The nozzle body portion 12B has a concave inner surface 31. In an alternative embodiment, the nozzle body portions 12A, 12B may be integrated as a single, unitary piece. In other alternative embodiments, the inner surface may be straight, rather than concave. An electrode wire, referred to herein as the electrode 29, is shown in part. A remaining portion of the electrode 29 is spooled, and fed into the nozzle body 12A, 12B as the electrode is consumed during welding, as is known. A power supply 17 provides electrical power to the electrode 29.

The gun 11 is preferably a MIG-type welding gun, and is used to weld a work piece 16. The welding gun 11 is mounted to a robotic assembly, represented by a robot arm 18, that is electronically, hydraulically, pneumatically, or otherwise powered to move the welding gun 11 and thereby control the position of the gun 11 and nozzle orifice 15 relative to the work piece 16. The work piece 16 is mounted on a base 20 during welding, and may be clamped or otherwise secured thereto. Position sensors 22 are secured to the base 20 and to the gun 11. The position sensors 22 are operatively connected to an electronic controller 24, which contains a processor with an algorithm configured to interpret position data retrieved from the sensors 22 and control the arm 18 to reposition the gun 11 as necessary in order to maintain a desired position of the gun 11 relative to the work piece 16. The controller 24 also controls the power supply 17.

Specifically, the controller 24 is programmed to position the nozzle orifice 15 a distance D from a surface 26 of the work piece 16. Alternatively, the distance D may be established from the surface of the base 20 facing the gun 11. In either case, the distance D is selected to allow the nozzle orifice 15 to be sufficiently close enough to the work piece 16 so that weld spatter 28 (created by the electrode 29 or by the resulting arc 30 between the electrode 29 and work piece 16) that is initially ejected from a weld pool 32 will enter into the cavity 13 and deflect off of an inner surface 31 of the nozzle body portion 12B, and back into the weld pool 32 situated below the nozzle orifice 15. The spatter 28, and other spatter referred to in the drawings, may deflect several times off of the inner surface 31 before deflecting back to the weld pool 32. Typically, weld guns are spaced too far from a work piece 16 to enable redirection of weld spatter in this manner. This is partly due to shielding gas 34 flowing out of the opening. Shielding gas 34 is used to protect the electrode, arc and weld pool from ambient air, as air tends to oxidize the weld, leading to porosity that can weaken the weld. Additionally, the shielding gas provides a buffer to prevent drafts in the surroundings from affecting the arc and weld pool. A significant flow rate of shielding gas is typically required in order to accomplish these objectives. With a relatively high flow rate, a large gap is required between the work piece and the nozzle orifice in order to maintain laminar flow of the gas.

The controller 24 controls the flow rate of shielding gas from a gas supply 36 in order to maintain laminar flow at the nozzle orifice 15. Specifically, the controller 24 may control the position of a valve 38 to vary the flow rate of shielding gas. Thus, laminar flow is maintained while a predetermined distance D is also maintained. The distance D is determined based on a variety of factors, such as the expected size of the weld pool 32, the size of nozzle orifice 15, the material of both the work piece 16 and electrode 29.

In FIG. 1, the weld spatter 28 ejected from weld pool 32 hits the inner surface 31 of nozzle body portion 12B at a position 28A, is deflected off of inner surface 31 to a position 28B in which it is used in the weld pool 32. A separate weld spatter 28D ejected from weld pool 32 is directed to position 28E and then deflected to position 28F, at which it is close enough to the weld pool 32 such that surface tension of the pool 32 will pull the spatter at position 28F into the pool 32. Accordingly, the apparatus 10 is configured so that weld spatter 28, 28D is captured and redirected to be used for its intended purpose (forming a weld). It is noted that the nozzle body portion 12B has a concave shape at the inner surface 31, which helps in to focus and redirect the spatter toward the center of the cavity 13, to enable its use in the weld pool 32.

Referring to FIG. 2, another embodiment of a robotic welding apparatus 110 is shown. The welding apparatus 110 has a weld gun 111 that has a nozzle body 112A, 112B formed from a first nozzle body portion 112A and a second nozzle body portion 112B. A coil spring 140 is positioned between an end of the first nozzle body portion 112A and an annular shoulder 142 of the second nozzle body portion 112B that protrudes inward in the cavity 113 formed by the nozzle body portions 112A, 112B. An outward-protruding annular lip 144 of the first nozzle body portion 112A interferes with an inward protruding annular lip 146 of the second nozzle body portion 112B to establish one extreme in relative axial positions of the nozzle body portions 112A, 112B. The second nozzle body portion 112B is biased to the position shown, but is free to move axially relative to the first nozzle body portion 112A (upward in the view of FIG. 2), if the spring 140 is compressed, such as if the work piece 16 bumps the nozzle body portion 112B. Without an external force, the spring 140 will return the second nozzle body portion 112B to the position shown. The second nozzle body portion 112B may be referred to as a nozzle extension and defines a distal opening 114 and a gas nozzle orifice 115 for laminar flow of the shielding gas 34. Weld spatter 28G and 28H are shown in the process of being deflected by the inner surface 131 of the second nozzle body portion 112B toward the weld pool 32.

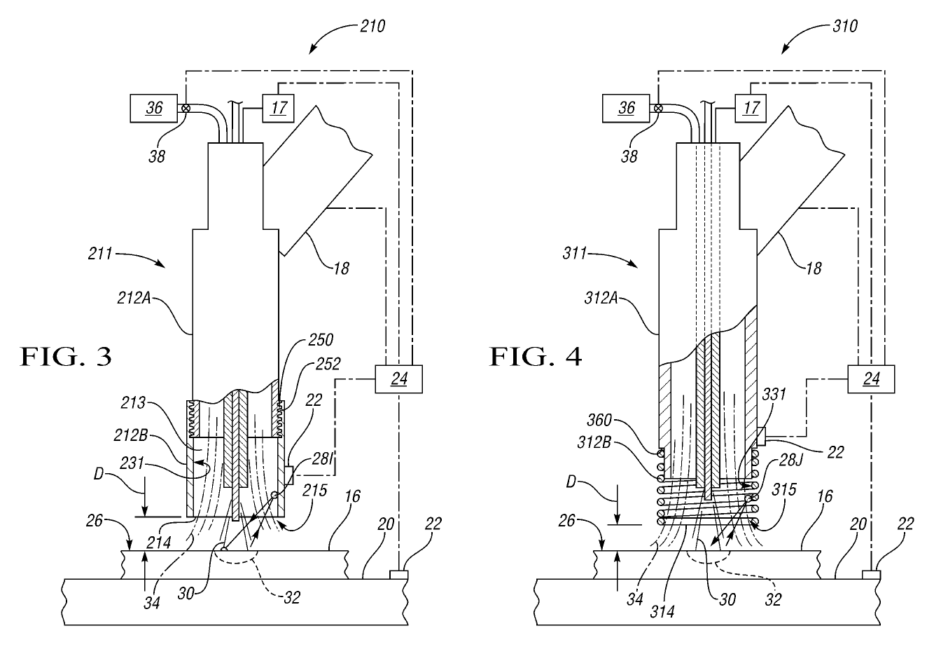

Referring to FIG. 3, another embodiment of a robotic welding apparatus 210 is shown. The welding apparatus 210 has a weld gun 211 that has a nozzle body 212A, 212B formed from a first nozzle body portion 212A and a second nozzle body portion 212B. The first nozzle body portion 212A has an outwardly-threaded portion 250. The second nozzle body portion 212B has an inwardly-threaded portion 252, configured to be threaded onto the first nozzle body portion 212B to define cavity 213 therewith. The second nozzle body portion 212B may be referred to as a nozzle extension, and defines a distal opening 214 and a gas nozzle orifice 215 for laminar flow of the shielding gas 34. Weld spatter 281 is shown in the process of being deflected by the inner surface 231 of the second nozzle body portion 212B toward the weld pool 32. The apparatus may have a design advantage in that only the relatively inexpensive and easily removable second nozzle body portion 212B may need replacement after wear.

Referring to FIG. 4, another embodiment of a robotic welding apparatus 310 is shown. The welding apparatus 310 has a weld gun 311 that has a nozzle body 312A, 312B formed from a first nozzle body portion 312A and a second nozzle body portion 312B. The second nozzle body portion 312B is a coil spring that is connected to the first nozzle body portion 312A at an annular shoulder 360 of the first nozzle body portion 312A. The second nozzle body portion 312B may be referred to as a nozzle extension, and defines a distal opening 314 and a gas nozzle orifice 315 for laminar flow of the shielding gas 34. Similar to the embodiment of FIG. 2, the nozzle body 312B is temporarily compressed if work piece 16 bumps the second nozzle body portion 312B. The second nozzle body portion 312B will compress relative to the first nozzle body portion 312A, and then return to the position shown in FIG. 4, under the control of the controller 24, to provide laminar flow of the shielding gas 34. Weld spatter 28J is shown in the process of being deflected by the inner surface 331 of the second nozzle body portion 312B toward the weld pool 32. The spring pitch (i.e., axial distance between turns of the spring of the second nozzle body portion 312B) and the spring diameter (i.e., diameter of the spring wire of second nozzle body portion 312B) may be optimized to produce optimal laminar gas flow and spatter redirecting capability.

While the best modes for carrying out the invention have been described in detail, those familiar with the art to which this invention relates will recognize various alternative designs and embodiments for practicing the invention within the scope of the appended claims.

1. A welding apparatus for welding a work piece comprising:
a welding gun with a nozzle body having an inner surface defining a cavity, a distal opening forming a nozzle orifice, and an electrode extending in the cavity configured to be positionable proximate the work piece; wherein the weld gun is configured to provide a flow of shielding gas through the nozzle orifice; wherein the welding apparatus is configured to position the nozzle orifice at a distance from the work piece sufficient to cause the inner surface to direct weld spatter to a weld pool on the work piece adjacent the nozzle orifice.

2. The welding apparatus of claim 1, wherein the distance is selected to maintain laminar flow of shielding gas through the nozzle orifice.

3. The welding apparatus of claim 1, wherein the nozzle body comprises a first nozzle body portion and a second nozzle body portion extending from the first nozzle body portion to define therewith the cavity; and wherein the second nozzle body portion defines the nozzle orifice.

4. The welding apparatus of claim 3, further comprising:
a spring operatively connecting the first and second nozzle body portions and surrounding the cavity; and wherein the first and second nozzle body portions are configured to be axially movable relative to one another by compression of the spring.

5. The welding apparatus of claim 3, wherein the second nozzle body portion is configured as a coil spring.

6. The welding apparatus of claim 3, wherein the first and second nozzle body portions are configured with matable threads, the second nozzle body portion thereby being connectable or removable from the first nozzle body portion by threading the second nozzle body portion onto or off of the first nozzle body portion, respectively.

7. The welding apparatus of claim 1, wherein the inner surface is concave proximate the nozzle orifice; and wherein the concave inner surface is configured to direct weld spatter to the weld pool.

8. A robotic welding apparatus for welding a work piece comprising:
a base configured to support the work piece during welding;
a weld gun with a nozzle body defining a cavity, a distal opening forming a nozzle orifice, and having an electrode extending in the cavity configured to be positionable proximate the work piece; wherein the weld gun is configured to provide a flow of shielding gas through the nozzle orifice; and
a controller operatively connected to the weld gun and operable to position the nozzle orifice at a distance not more than 3 millimeters from the work piece during the welding while controlling flow rate through the nozzle orifice to maintain laminar flow.

9. The robotic welding apparatus of claim 8, wherein the distance is selected to enable redirection of weld spatter via an inner surface of the nozzle body in the cavity.

10. The robotic welding apparatus of claim 8, wherein the nozzle body comprises a first nozzle body portion and a second nozzle body portion extending from the first nozzle body portion to define therewith the cavity; and wherein the second nozzle body portion defines the nozzle orifice.

11. The robotic welding apparatus of claim 10, further comprising:
a spring operatively connecting the first and second nozzle body portions and surrounding the cavity; and wherein the first and second nozzle body portions are configured to be axially movable relative to one another by compression of the spring.

12. The robotic welding apparatus of claim 10, wherein the second nozzle body portion is configured as a coil spring.

13. The robotic welding apparatus of claim 10, wherein the first and second nozzle body portions are configured with matable threads, the second nozzle body portion thereby being connectable or removable from the first nozzle body portion by threading the second nozzle body portion onto or off of the first nozzle body portion, respectively.

14. The robotic welding apparatus of claim 10, wherein the nozzle body has a concave inner surface proximate the nozzle orifice; and wherein the concave inner surface is configured to direct weld spatter to the weld pool.

15. A method of welding a work piece comprising:
controlling a distance between a weld gun and a work piece when welding the work piece to permit weld spatter to deflect off of the weld gun into or toward a weld pool on the work piece; and
controlling a rate of shielding gas flow through the weld gun so that laminar flow of shielding gas from the weld gun is maintained.
